(19) United States
(12) Patent Application Publication
(10) Pub. No.: US 2023/0098086 A1
(43) Pub. Date: Mar. 30, 2023

(54) STORING FORM FIELD DATA

(71) Applicant: Hewlett-Packard Development Company, L.P., Spring, TX (US)

(72) Inventors: Peter G. Hwang, Vancouver, WA (US); Tae-Jung Yun, Pangyo (KR)

(21) Appl. No.: 17/449,503

(22) Filed: Sep. 30, 2021

(51) Int. Cl. G06F 16/2457; G06N 5/02; G06F 16/248; G06K 9/00

(52) U.S. Cl. CPC G06F 16/24578; G06N 5/022; G06F 16/248; G06K 9/00449; G06K 2209/01

(57) ABSTRACT

Examples disclosed herein relate to scanning a document comprising a plurality of data elements, mapping, according to a plurality of metadata associated with the scanned document, at least one of the plurality of data elements to a form field according to a trained machine-learning model, and applying the at least one of the plurality of data elements to the form field.

### BACKGROUND

Multi-function devices often combine different components such as a printer, scanner, and copier into a single device. Such devices frequently receive refills of consumables, such as print substances (e.g., ink, toner, and/or additive materials) and/or media (e.g., paper, vinyl, and/or other print substrates). In many cases, these devices may be interconnected to other devices, storage locations, and/or computers via communication networks.

### BRIEF DESCRIPTION OF THE DRAWINGS

FIGS. 1A-1B are examples of a scanned document and a form.

FIG. 2 is a block diagram of an example computing device for storing form field data.

FIG. 3 is a flowchart of a first example method for storing form field data.

FIG. 4 is a flowchart of a second example method for storing form field data.

FIG. 5 is a block diagram of an example system for storing form field data.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Most multi-function-print devices (MFPs) provide several features, such as an option to scan a physical document, which may be controlled via an on-device control panel, a connected application, and/or a remote service. Other options may include printing, copying, faxing, document assembly, etc. The scanning portion of an MFP may comprise an optical assembly located within a sealed enclosure. The sealed enclosure may have a scan window through which the optical assembly can scan a document, which may be placed on a flatbed and/or delivered by a sheet feeder mechanism.

In some situations, documents may be scanned into an MFP or other device, such as a camera, smartphone, and/or other image capture device. The document may comprise data elements that a user may desire to transfer to an electronic form comprising a number of fields. For example, an invoice may be scanned comprising an amount and date due that may be entered into a payment system. In order to simplify this task, a machine-learning model may be employed to learn which data elements on the scanned document are associated with which fields and automatically transfer those elements to the appropriate form fields.

A machine-learning model may rely on a plurality of trained feature vectors, which may include image and/or textual feature vectors, that represent properties of a textual representation. For example, a textual feature vector may represent similarity of words, linguistic regularities, contextual information based on trained words, description of shapes, regions, proximity to other vectors, etc. The feature vectors may be representable in a multimodal space. A multimodal space may include k-dimensional coordinate system. When the image and textual feature vectors are populated in the multimodal space, similar image features and textual features may be identified by comparing the distances of the feature vectors in the multimodal space to identify a matching image to the query. One example of a distance comparison may include a cosine proximity, where the cosine angles between feature vectors in the multimodal space are compared to determine closest feature vectors. Cosine similar features may be proximate in the multimodal space, and dissimilar feature vectors may be distal. Feature vectors may have k-dimensions, or coordinates in a multimodal space. Feature vectors with similar features are embedded close to each other in the multimodal space in vector models.

Feature-based vector representation may use various models, to represent words, images, and structures of a document in a continuous vector space. For example, heading words (e.g., “Date Due”, “Account Number”, “Balance”, etc.) may be treated as metadata words that indicate a data element of interest. Document structures, such as locations of various data elements (e.g., adjacent to a heading word), a type of data element (e.g., a currency indicator, numbers in a date format, etc.), or images (e.g., a company logo) may be identified as data elements that may be of interest in completing a given form.

Different techniques may be applied to represent different features in the vector space, and different levels of features may be stored according to the number of documents that may need to be maintained. For example, semantically similar words may be mapped to nearby points by relying the fact that words that appear in the same contexts share semantic meaning. Two example approaches that leverage this principle comprise count-based models (e.g., Latent Semantic Analysis) and predictive models (e.g., neural probabilistic language models). Count-based models compute the statistics of how often some word co-occurs with its neighbor words in a large text corpus, and then map these count-statistics down to a small, dense vector for each word. Predictive methods directly try to predict a word from its neighbors in terms of learned small, dense embedding vectors (considered parameters of the model). Other layers may capture other features, such as font type distribution, layout, image content and positioning, color maps, etc.

In some implementations, a machine-learning model may be trained on a large set of scanned documents, such as technical papers, news articles, fiction and/or non-fiction works, invoices, etc. In some implementations, the model may be trained on a set of documents associated with a form to be completed. The model may thus interpolate the semantic meanings and similarities of different words. For example, the model may learn that the words “Obama speaks to the media in Illinois” is semantically similar to the words “President greets the press in Chicago” by finding two similar news stories with those headlines. The machine-learning model may comprise, for example, a word2vec model trained with negative sampling. Word2vec is a computationally efficient predictive model for learning word embeddings from raw text. It may rely on various models, such as the Continuous Bag-of-Words model (CBOW) and the Skip-Gram model. CBOW, for example predicts target words (e.g., ‘mat’) from source context words ('the cat sits on the'), while the skip-gram does the inverse and predicts source context-words from the target words. The machine learning model may also comprise of other types of vector representations for words, such as Global Vectors (GloVe)-, or any other form of word embeddings. By extracting feature vectors from a set of similar documents comprising similar data elements, each data element may be made available to complete form fields of similar data types.

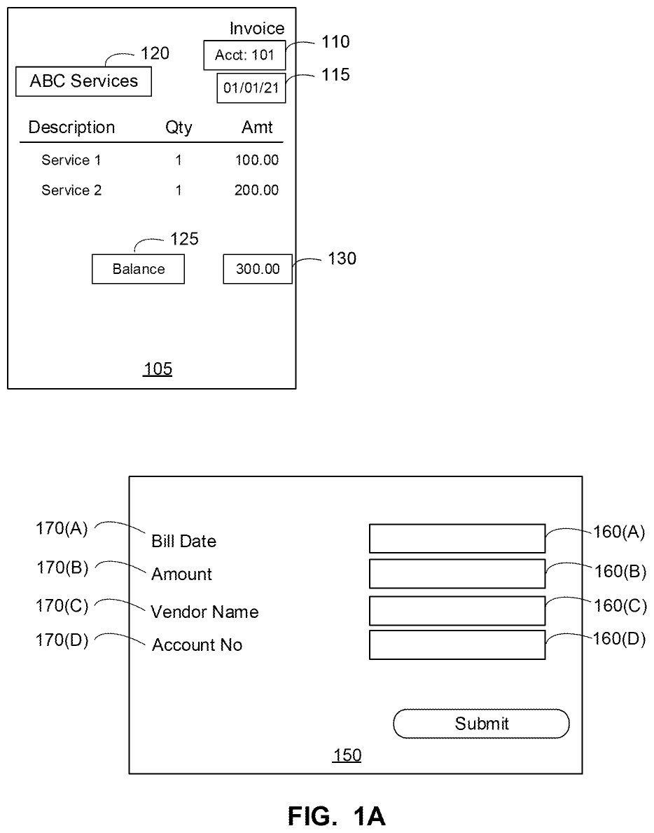

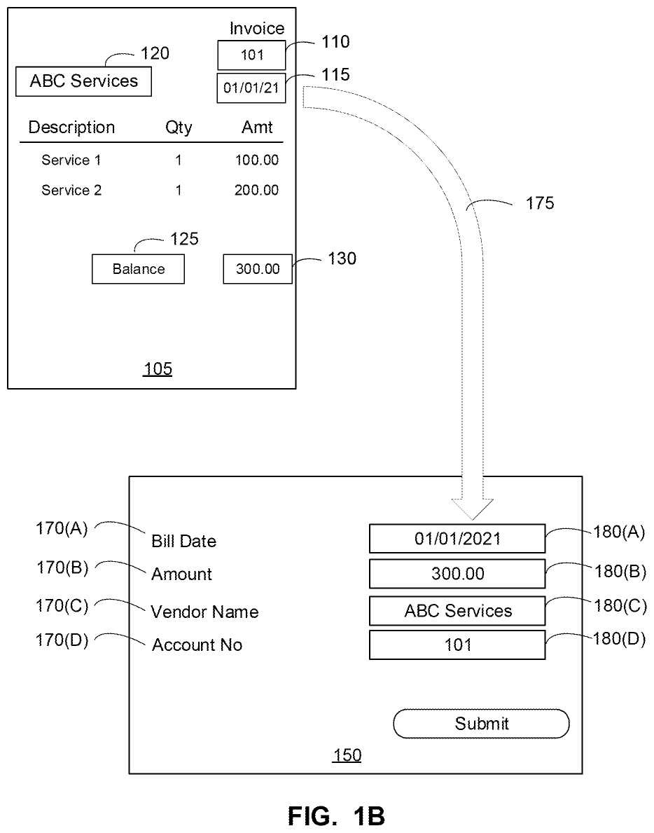

FIG. 1A is an example of a scanned document 105 to be mapped to a form 150. Scanned document 105 may comprise, for example, an account number data element 110, a date due data element 115, a company name data element 120, a balance metadata 125, and a balance due data element 130. Form 150, such as may be associated with a payment system, may comprise an electronically displayed user interface (UI), such as may be displayed on a control panel, smartphone, laptop, computer, and/or other electronic device. The form may comprise a plurality of form fields 160(A)-160(D) and a plurality of form field labels 170(A)-170(D).

FIG. 1B is an example of scanned document 105 and form 150 after the data elements of scanned document 105 have been mapped 175 onto a plurality of completed form fields 180(A)-180(D) of form 150. For example, account number data element 110 has been mapped into completed form field 180(D) with form field label 170(D) “Account No”. Date due data element 115 has been mapped into completed form field 180(A) with form field label 170(A) “Bill Date”. Company name data element 120 has been mapped into completed form field 180(C) with form field label 170(C) “Vendor Name”. In some implementations, company name data element 120 may comprise an image and/or logo. A machine-learning model may be trained to translate that image into a textual representation of the company name. Balance due data element 130 has been mapped into completed form field 180(B) with form field label 170(B) “Amount”.

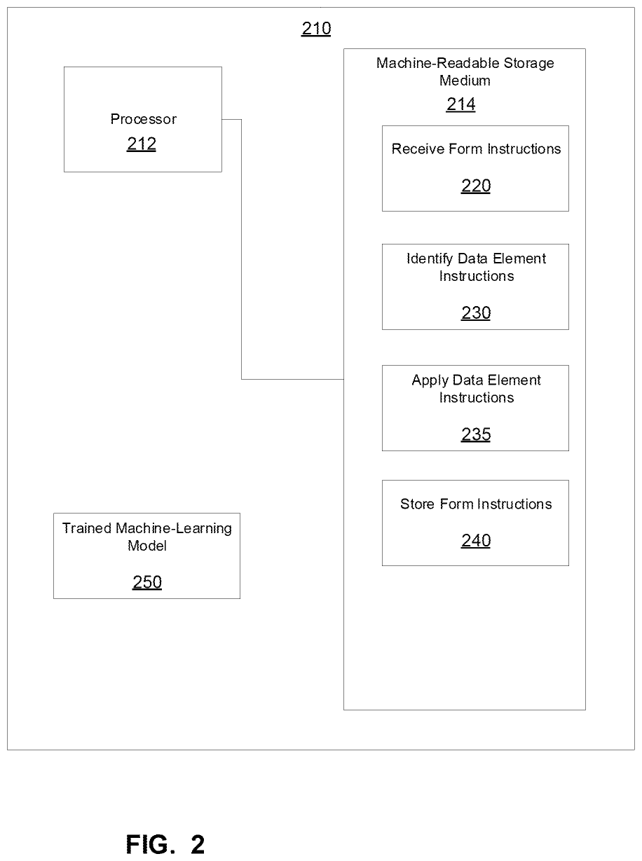

FIG. 2 is a block diagram of an example computing device 210 for storing form field data. Computing device 210 may comprise a processor 212 and a non-transitory, machine-readable storage medium 214. Storage medium 214 may comprise a plurality of processor-executable instructions, such as receive form instructions 120, identify data element instructions 230, apply data element instructions 235, and store form instructions 240. Device 210 may further comprise a trained machine-learning model 250. In some implementations, instructions 220, 230, 235, 240 may be associated with a single computing device 110 and/or may be communicatively coupled among different computing devices such as via a direct connection, bus, or network.

Processor 212 may comprise a central processing unit (CPU), a semiconductor-based microprocessor, a programmable component such as a complex programmable logic device (CPLD) and/or field-programmable gate array (FPGA), or any other hardware device suitable for retrieval and execution of instructions stored in machine-readable storage medium 214. In particular, processor 212 may fetch, decode, and execute instructions 220, 230, 235, 240.

Executable instructions 220, 230, 235, 240 may comprise logic stored in any portion and/or component of machine-readable storage medium 214 and executable by processor 212. The machine-readable storage medium 214 may comprise both volatile and/or nonvolatile memory and data storage components. Volatile components are those that do not retain data values upon loss of power. Nonvolatile components are those that retain data upon a loss of power.

The machine-readable storage medium 214 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, and/or a combination of any two and/or more of these memory components. In addition, the RAM may comprise, for example, static random-access memory (SRAM), dynamic random-access memory (DRAM), and/or magnetic random-access memory (MRAM) and other such devices. The ROM may comprise, for example, a programmable read-only memory (PROM), an erasable programmable read-only memory (EPROM), an electrically erasable programmable read-only memory (EEPROM), and/or other like memory device.

Trained machine-learning model 250 may comprise a plurality of feature-based vector representations. Model 250 may be trained as described above, for example, on a plurality of scanned documents associated with completing a form, such as form 150. In some implementations, model 250 may be stored in machine-readable storage medium 214, in another memory location, and/or on a communicatively coupled separate device.

In some implementations, the trained machine-learning model 250 may utilize a training corpus of a plurality of scanned documents associated with a particular user and/or a particular form. Similar forms may use the same machine-learning model 250, but in some implementations, different forms may use different machine-learning models. For example, different forms associated with an accounting system and/or program may use trained machine-learning model 250 but forms associated with a bug tracking and/or code repository system may use a different machine-learning model to accomplish similar tasks as to those described herein.

In some implementations, model 250 may comprise a plurality of feature vectors comprising classifications for a plurality of scanned data elements from the plurality of scanned documents based on a plurality of metadata associated with a plurality of structural elements of the plurality of scanned documents.

In some implementations, the trained machine-learning model may comprise a plurality of form field classifications trained on a plurality of completed forms utilizing the plurality of scanned data elements. For example, the plurality of completed forms each comprise a plurality of completed fields based on selections, by the user, from among the plurality of scanned data elements. A completed field may comprise, for example, completed form field 180(A)-(D).

Receive form instructions 220 may receive a form comprising a plurality of fields. For example, device 210 may execute a program that displays a user interface comprising form 150. Form 150 may be received, for example, in response to a user request for the form via a control panel and/or other user interface device (e.g., keyboard, mouse, touchscreen, etc.).

Identify data element instructions 230 may identify a data element associated with at least one of the plurality of fields according to a trained machine-learning model. For example, a document such as scanned document 105 may be received by device 210, such as by scanning a physical copy of the document to generate scanned document 105. Optical character recognition (OCR) may, in some implementations, be employed to translate the scanned image of the document to a machine-readable text version comprising scanned document 105. Machine-learning model 250 may use metadata, such as the document structure, learned from similar documents to identify one and/or more data elements from the document that may be associated with fields in the received form. For example, model 250 may identify balance due data element 130 from document 105 as being associated with form field 160(B) of form 150.

Optical character recognition is the electronic conversion of images of typed, handwritten, and/or printed text into machine-encoded text, whether from a scanned document, a photo of a document, a scene-photo (for example the text on signs and billboards in a landscape photo) or from subtitle text superimposed on an image (for example: from a television broadcast).

In some implementations the instructions 230 to identify the data element associated with the at least one of the plurality of fields according to the trained machine-learning model comprise instructions to classify the at least one of the plurality of fields and to identify a subset of the plurality of scanned data elements associated with the classification of the at least one of the plurality of fields. For example, form field 160(A) of form 150 may be classified as a date type field, and date due data element 115 of document 105 may be classified as a date type data element.

Identify data element instructions 230 may further comprise instructions to identify a plurality of possible data elements associated with the at least one of the plurality of fields according to the trained machine-learning model. In some implementations, a document may comprise multiple data elements that may be appropriate for a given form field. For example, document 105 comprises date due data element 115 in the example of FIG. 1A, but such a document may also comprise an invoice date in addition to the due date. Both dates may match the format and/or structure expected for the “Bill Date” form field 160(A) and may be identified as possible data elements associated with form field 160(A). In some implementations, model 250 may assign a likelihood score to each of the possible data elements representing a ranking of which data element appears to be most likely to be the one associated with a given form field. For example, all invoice type documents may have date due data element 115 in approximately the same place, but some documents may have an invoice date in a different area or omit it altogether, and/or may have different metadata such as descriptive text near date due data element 115 that help indicate which date is the one most likely associated with form field 160(A). As more invoices are processed by device 210, model 250 may be updated to learn which, if any, of the date type data elements are most likely to be used to fill in form field 160(A) and aid in improving the likelihood score for a given data element.

Identify data element instructions 230 may further comprise instructions to receive a selection of a chosen data element to apply to the at least one of the plurality of fields from a user associated with the form. For example, device 210 may display some and/or all of the possible data elements to a user, such as on a control panel, screen, and/or other interactive display. In some implementations, identify data element instructions 230 may further comprise instructions to display the plurality of possible data elements in an order based on a likelihood score according to the trained machine-learning model. For example, the possible data element with the highest confidence of being associated with a given form field may be displayed first and/or at the top of a list of the possible data elements. A user may then select one of the possible data elements to be applied to the form field, such as via an electronically displayed user interface.

Identify data element instructions 230 may further comprise instructions to update the likelihood score of the chosen data element in the trained machine-learning model based on the selection of the chosen data element. For example, if the user selects the data element already assigned the highest likelihood score by model 250, the likelihood scores of the other data elements may be reduced if a similar document is processed at a later time. If the user selects one of the other possible data elements, the likelihood score of the highest scored data element may be reduced and/or the likelihood score of the selected data element may be increased. This adjustment of likelihood scores may be applied in machine-learning model 250 as a type of ongoing training.

Apply data element instructions 235 may apply the data element to the at least one of the plurality of fields. For example, the identified data element and/or selected data element from the plurality of identified data element may be mapped to and entered in an associated form field. In FIG. 1B, for example, date due data element 115 has been applied to completed form field 180(A).

Store form instructions 240 may store the form with the data element applied to the at least one of the plurality of fields. Storing the form may comprise, for example, saving the completed field data to memory, submitting the form and data for further processing, transmitting the form and/or data, such as by email, printing the completed form, and/or otherwise saving the association between data element(s) and form field(s) for later retrieval and/or review.

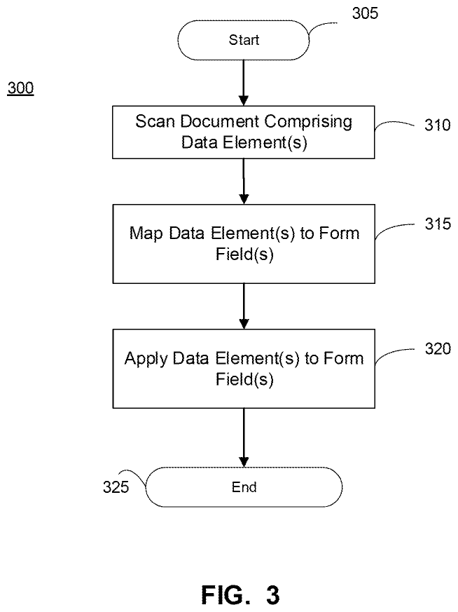

FIG. 3 is a flowchart of a first example method 300 for storing form field data. Although execution of method 300 is described below with reference to computing device 210, other suitable components for execution of method 300 may be used.

Method 300 may begin at stage 305 and advance to stage 310 where device 210 may scan a document comprising a plurality of data elements. For example, device 210 may comprise an optical scanner operative to receive a physical document and convert it to an electronic representation, such as an image file and/or other electronically manipulatable format.

Method 300 may then advance to stage 315 where computing device 210 may map, according to a plurality of metadata associated with the scanned document, at least one of the plurality of data elements to a form field according to a trained machine-learning model. For example, device 210 may execute identify data element instructions 230 to identify a data element associated with a field of a form according to a trained machine-learning model. The machine-learning model, such as model 250, may analyze the document to identify a plurality of possible data elements and, using domain knowledge gained from training, as described above, select one and/or a plurality of data elements that appear to be associated with one and/or more fields in a form.

Method 300 may then advance to stage 320 where computing device 210 may apply the at least one of the plurality of data elements to the form field. For example, device 210 may execute apply data element instructions 235 to apply the data element to the at least one of the plurality of fields. For example, the identified data element and/or selected data element from the plurality of identified data element may be mapped to and entered in an associated form field. In FIG. 1B, for example, date due data element 115 has been applied to completed form field 180(A).

Method 300 may then end at stage 325.

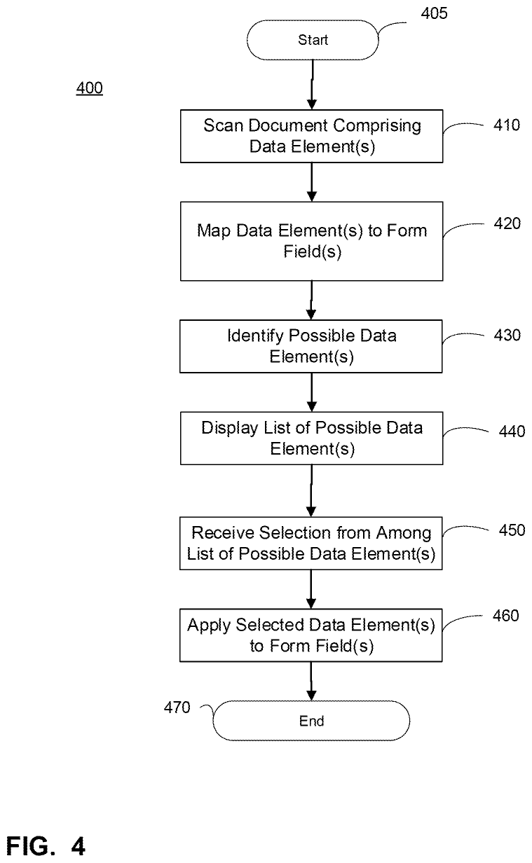

FIG. 4 is a flowchart of a second example method 400 for storing form field data. Although execution of method 400 is described below with reference to computing device 210, other suitable components for execution of method 400 may be used.

Method 400 may begin at stage 405 and advance to stage 410 where device 210 may scan a document comprising a plurality of data elements. For example, device 210 may comprise an optical scanner operative to receive a physical document and convert it to an electronic representation, such as an image file and/or other electronically manipulatable format.

Method 400 may then advance to stage 420 where computing device 210 may map, according to a plurality of metadata associated with the scanned document, at least one of the plurality of data elements to a form field according to a trained machine-learning model. For example, device 210 may execute identify data element instructions 230 to identify a data element associated with a field of a form according to a trained machine-learning model. The machine-learning model, such as model 250, may analyze the document to identify a plurality of possible data elements and, using domain knowledge gained from training, as described above, select one and/or a plurality of data elements that appear to be associated with one and/or more fields in a form.

In some implementations, mapping the at least one of the plurality of data elements to the form field according to the trained machine-learning model may comprise updating a likelihood score of the selected data element from among the list of possible data elements in the trained machine-learning model. For example, trained machine-learning model 250 may assign a likelihood score to each of the possible data elements representing a ranking of which data element appears to be most likely to be the one associated with a given form field. For example, all invoice type documents may have date due data element 115 in approximately the same place, but some documents may have an invoice date in a different area or omit it altogether, and/or may have different metadata such as descriptive text near date due data element 115 that help indicate which date is the one most likely associated with form field 160(A). As more invoices are processed by device 210, model 250 may be updated to learn which, if any, of the date type data elements are most likely to be used to fill in form field 160(A) and aid in improving the likelihood score for a given data element.

Device 210 may, for example, execute identify data element instructions 230 to update the likelihood score of the chosen data element in the trained machine-learning model based on the selection of the chosen data element. For example, if the user selects the data element already assigned the highest likelihood score by model 250, the likelihood scores of the other data elements may be reduced if a similar document is processed at a later time. If the user selects one of the other possible data elements, the likelihood score of the highest scored data element may be reduced and/or the likelihood score of the selected data element may be increased. This adjustment of likelihood scores may be applied in machine-learning model 250 as a type of ongoing training.

Method 400 may then advance to stage 430 where computing device 210 may identify a list of possible data elements from the plurality of data elements. In some implementations, method 300 may execute identify data element instructions 230 to identify a plurality of possible data elements associated with the at least one of the plurality of fields according to the trained machine-learning model. In some implementations, a document may comprise multiple data elements that may be appropriate for a given form field. For example, document 105 comprises date due data element 115 in the example of FIG. 1A, but such a document may also comprise an invoice date in addition to the due date. Both dates may match the format and/or structure expected for the “Bill Date” form field 160(A) and may be identified as possible data elements associated with form field 160(A).

Method 400 may then advance to stage 440 where computing device 210 display the list of possible data elements in an order based on a likelihood score according to the trained machine-learning model. For example, device 210 may display some and/or all of the possible data elements to a user, such as on a control panel, screen, and/or other interactive display. In some implementations, identify data element instructions 230 may further comprise instructions to display the plurality of possible data elements in an order based on a likelihood score according to the trained machine-learning model. For example, the possible data element with the highest confidence of being associated with a given form field may be displayed first and/or at the top of a list of the possible data elements.

Method 400 may then advance to stage 450 where computing device 210 may receive, via a user interface, a selection from among the list of possible data elements to apply to the form field. Device 210 may, for example, execute identify data element instructions 230 to receive a selection of a chosen data element to apply to the at least one of the plurality of fields from a user associated with the form. For example, device 210 may display some and/or all of the possible data elements to a user, such as on a control panel, screen, and/or other interactive display. A user may then select one of the possible data elements to be applied to the form field.

Method 400 may then advance to stage 460 where computing device 210 apply the at least one of the plurality of data elements to the form field. For example, device 210 may execute apply data element instructions 235 to apply the data element to the at least one of the plurality of fields. For example, the identified data element and/or selected data element from the plurality of identified data element may be mapped to and entered in an associated form field. In FIG. 1B, for example, date due data element 115 has been applied to completed form field 180(A).

Method 400 may then end at stage 470.

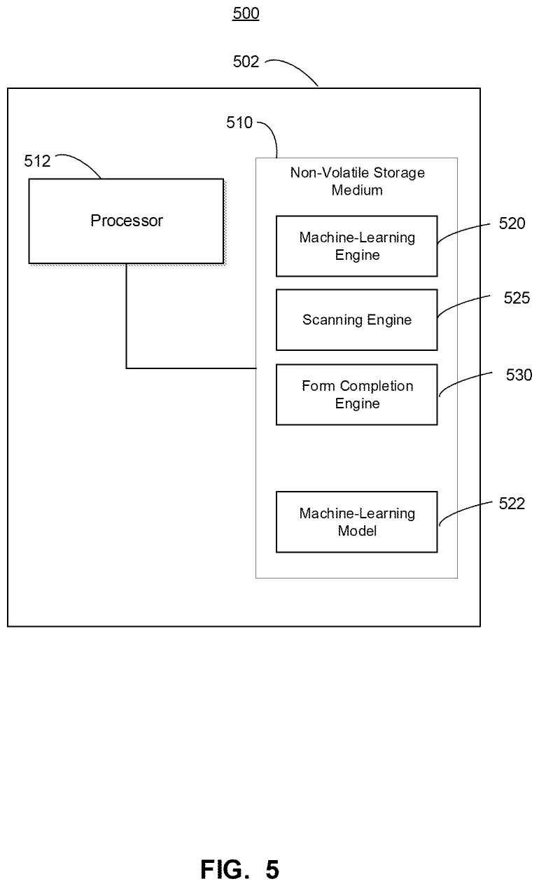

FIG. 5 is a block diagram of an example apparatus 500 for storing form field data. Apparatus 500 may comprise, for example, a multi-function printer device 502 comprising a storage medium 510 and a processor 512. Device 502 may comprise and/or be associated with, for example, a general and/or special purpose computer, server, mainframe, desktop, laptop, tablet, smart phone, game console, printer, multi-function device, and/or any other system capable of providing computing capability consistent with providing the implementations described herein. Device 502 may store, in storage medium 510, a machine-learning engine 520, a machine-learning model 522, a scanning engine 525, and a form completion engine 530.

Machine-learning engine 520 may train machine-learning model 522 to classify a plurality of data elements from a plurality of scanned documents and a plurality of form fields according to a plurality of mappings between the plurality of data elements and the plurality of form fields. For example, a machine-learning model may be trained on a large set of scanned documents, such as technical papers, news articles, fiction and/or non-fiction works, invoices, etc. In some implementations, the model may be trained on a set of documents associated with a form to be completed. The model may thus interpolate the semantic meanings and similarities of different words. For example, the model may learn that the words “Obama speaks to the media in Illinois” is semantically similar to the words “President greets the press in Chicago” by finding two similar news stories with those headlines. The machine-learning model may comprise, for example, a word2vec model trained with negative sampling. Word2vec is a computationally efficient predictive model for learning word embeddings from raw text. It may rely on various models, such as the Continuous Bag-of-Words model (CBOW) and the Skip-Gram model. CBOW, for example predicts target words (e.g., ‘mat’) from source context words (‘the cat sits on the’), while the skip-gram does the inverse and predicts source context-words from the target words. The machine learning model may also comprise of other types of vector representations for words, such as Global Vectors (GloVe)-, or any other form of word embeddings. By extracting feature vectors from a set of similar documents comprising similar data elements, each data element may be made available to complete form fields of similar data types.

Machine-learning engine 520 may also update machine-learning model 522 upon a selection of at least one of the plurality of data elements to be applied to at least one of the plurality of form fields. For example, machine-learning model 522 may assign a likelihood score to each of the possible data elements representing a ranking of which data element appears to be most likely to be the one associated with a given form field. For example, all invoice type documents may have date due data element 115 in approximately the same place, but some documents may have an invoice date in a different area or omit it altogether, and/or may have different metadata such as descriptive text near date due data element 115 that help indicate which date is the one most likely associated with form field 160(A). As more invoices are processed by device 502, machine-learning model 522 may be updated to learn which, if any, of the date type data elements are most likely to be used to fill in form field 160(A) and aid in improving the likelihood score for a given data element.

Machine-learning engine 520 may execute identify data element instructions 230 to update the likelihood score of the chosen data element in the trained machine-learning model based on the selection of the chosen data element. For example, if the user selects the data element already assigned the highest likelihood score by machine-learning model 522, the likelihood scores of the other data elements may be reduced if a similar document is processed at a later time. If the user selects one of the other possible data elements, the likelihood score of the highest scored data element may be reduced and/or the likelihood score of the selected data element may be increased. This adjustment of likelihood scores may be applied in machine-learning model 250 as a type of ongoing training.

Scanning engine 525 may perform a scanning operation to convert a physical document to an electronic representation and/or perform an optical character recognition (OCR) operation on the electronic representation of the physical document. For example, device 502 may comprise an optical scanner operative to receive a physical document and convert it to an electronic representation, such as an image file and/or other electronically manipulatable format. Optical character recognition (OCR) may, in some implementations, be employed to translate the scanned image of the document to a machine-readable text version comprising scanned document 105. Machine-learning model 250 may use metadata, such as the document structure, learned from similar documents to identify one and/or more data elements from the document that may be associated with fields in the received form. For example, model 250 may identify balance due data element 130 from document 105 as being associated with form field 160(B) of form 150.

Optical character recognition is the electronic conversion of images of typed, handwritten, and/or printed text into machine-encoded text, whether from a scanned document, a photo of a document, a scene-photo (for example the text on signs and billboards in a landscape photo) or from subtitle text superimposed on an image (for example: from a television broadcast).

Scanning engine 525 may further identify a plurality of scanned data elements based on the OCR operation. For example, scanning engine 525 may execute identify data element instructions 230 to identify a data element associated with at least one of the plurality of fields according to a trained machine-learning model. For example, a document such as scanned document 105 may be received by device 210, such as by scanning a physical copy of the document to generate scanned document 105. Optical character recognition (OCR) may, in some implementations, be employed to translate the scanned image of the document to a machine-readable text version comprising scanned document 105. Machine-learning model 250 may use metadata, such as the document structure, learned from similar documents to identify one and/or more data elements from the document that may be associated with fields in the received form. For example, model 250 may identify balance due data element 130 from document 105 as being associated with form field 160(B) of form 150.

Form completion engine 530 may select at least one of the plurality of scanned data elements for an empty form field according to the trained machine-learning model. For example, form completion engine 530 may execute identify data element instructions 230 to identify a data element associated with a field of a form according to a trained machine-learning model. The machine-learning model, such as model 250, may analyze the document to identify a plurality of possible data elements and, using domain knowledge gained from training, as described above, select one and/or a plurality of data elements that appear to be associated with one and/or more fields in a form.

Form completion engine 530 may further apply the selected at least one of the plurality of scanned data elements to the empty form field in a displayed user interface. For example, form completion engine 530 may execute apply data element instructions 235 to apply the data element to the at least one of the plurality of fields. For example, the identified data element and/or selected data element from the plurality of identified data element may be mapped to and entered in an associated form field. In FIG. 1B, for example, date due data element 115 has been applied to completed form field 180(A).

Each of engines 520, 525, 530 may comprise any combination of hardware and programming to implement the functionalities of the respective engine. In examples described herein, such combinations of hardware and programming may be implemented in a number of different ways. For example, the programming for the engines may be processor executable instructions stored on a non-transitory machine-readable storage medium and the hardware for the engines may include a processing resource to execute those instructions. In such examples, the machine-readable storage medium may store instructions that, when executed by the processing resource, implement engines 320, 325. In such examples, device 302 may comprise the machine-readable storage medium storing the instructions and the processing resource to execute the instructions, or the machine-readable storage medium may be separate but accessible to apparatus 300 and the processing resource.

In the foregoing detailed description of the disclosure, reference is made to the accompanying drawings that form a part hereof, and in which is shown by way of illustration how examples of the disclosure may be practiced. These examples are described in sufficient detail to allow those of ordinary skill in the art to practice the examples of this disclosure, and it is to be understood that other examples may be utilized and that process, electrical, and/or structural changes may be made without departing from the scope of the present disclosure.

What is claimed is:

1. A non-transitory machine-readable medium storing instructions executable by a processor to:
receive a form comprising a plurality of fields;
identify a data element associated with at least one of the plurality of fields according to a trained machine-learning model;
apply the data element to the at least one of the plurality of fields; and
store the form with the data element applied to the at least one of the plurality of fields.

2. The non-transitory machine-readable medium of claim 1, wherein the instructions to identify the data element further comprise instructions to identify a plurality of possible data elements associated with the at least one of the plurality of fields according to the trained machine-learning model.

3. The non-transitory machine-readable medium of claim 2, wherein the instructions to identify the data element further comprise instructions to display the plurality of possible data elements in an order based on a likelihood score according to the trained machine-learning model.

4. The non-transitory machine-readable medium of claim 2, wherein the instructions to identify the data element further comprise instructions to receive a selection of a chosen data element to apply to the at least one of the plurality of fields from a user associated with the form.

5. The non-transitory machine-readable medium of claim 4, wherein the instructions to identify the data element further comprise instructions to update the likelihood score of the chosen data element in the trained machine-learning model based on the selection of the chosen data element.

6. The non-transitory machine-readable medium of claim 1, wherein the trained machine-learning model comprises a training corpus of a plurality of scanned documents associated with a user associated with the form.

7. The non-transitory machine-readable medium of claim 6, wherein the trained machine-learning model comprises a plurality of classifications for a plurality of scanned data elements from the plurality of scanned documents based on a plurality of metadata associated with a plurality of structural elements of the plurality of scanned documents.

8. The non-transitory machine-readable medium of claim 7, wherein the instructions to identify the data element associated with the at least one of the plurality of fields according to the trained machine-learning model comprise instructions to classify the at least one of the plurality of fields and to identify a subset of the plurality of scanned data elements associated with the classification of the at least one of the plurality of fields.

9. The non-transitory machine-readable medium of claim 7, wherein the trained machine-learning model comprises a plurality of form field classifications trained on a plurality of completed forms utilizing the plurality of scanned data elements.

10. The non-transitory machine-readable medium of claim 9, wherein the plurality of completed forms each comprise a plurality of completed fields based on selections, by the user, from among the plurality of scanned data elements.

11. A method comprising:
scanning a document comprising a plurality of data elements;
mapping, according to a plurality of metadata associated with the scanned document, at least one of the plurality of data elements to a form field according to a trained machine-learning model; and
applying the at least one of the plurality of data elements to the form field.

12. The method of claim 11, further comprising:
identifying a list of possible data elements from the plurality of data elements; and
displaying the list of possible data elements in an order based on a likelihood score according to the trained machine-learning model.

13. The method of claim 12, further comprising:
receiving, via a user interface, a selection from among the list of possible data elements to apply to the form field.

14. The method of claim 13, wherein applying the at least one of the plurality of data elements to the form field according to the trained machine-learning model further comprises updating the likelihood score of the selected data element from among the list of possible data elements in the trained machine-learning model.

15. A system, comprising:
a machine-learning engine to:
train a machine-learning model to classify a plurality of data elements from a plurality of scanned documents and a plurality of form fields according to a plurality of mappings between the plurality of data elements and the plurality of form fields, and
update the machine-learning model upon a selection of at least one of the plurality of data elements to be applied to at least one of the plurality of form fields;
a scanning engine to:
perform a scanning operation to convert a physical document to an electronic representation,
perform an optical character recognition (OCR) operation on the electronic representation of the physical document, and
identify a plurality of scanned data elements based on the OCR operation; and
a form completion engine to:
select at least one of the plurality of scanned data elements for an empty form field according to the trained machine-learning model, and
apply the selected at least one of the plurality of scanned data elements to the empty form field in a displayed user interface.
